(19) United States
(12) Patent Application Publication
(10) Pub. No.: US 2006/0062345 A1
(43) Pub. Date: Mar. 23, 2006

(54) Method and device to stabilize boiling water reactors against regional mode oscillations

(76) Inventor: Yousef M. Farawila, Richland, WA (US)

Correspondence Address: Floyd E. Ivey;Liebler, Ivey, Connor & Berry, P.O. Box 6125, Kennewick, WA, 99336, US

(21) Appl. No.: 11/135,951

(22) Filed: May 24, 2005

Related U.S. Application Data
(60) Provisional application No. 60/612,589, filed on Sep. 23, 2004.

(51) Int. Cl. G21C 15/00

(52) U.S. Cl. 376/377

(57) ABSTRACT

A new method for stabilizing the regional mode power/flow oscillations in a boiling water reactor core is introduced in this invention. The method depends on introducing flow resistance or partitions in the common flow plena (upper core plenum and/or lower plenum). The said resistance or partitions function to reduce or prevent the flow communication between any two groups of fuel assemblies through the common plena, thus preventing the excitation of the neutron flux first azimuthal harmonic mode. The partition devices of this invention, which provide the flow resistance, must divide the flow area in a common core plenum into three or more flow paths, as dividing the plenum in two flow paths only would not prevent the instability but would simply result in re-orienting the instability neutral line dividing the core assemblies into two sides oscillating out-of-phase. Alternative embodiments of this invention are Mercedes sign three section dividers, or Cruciform four section dividers, which are placed inside the upper and/or lower plenum of a boiling water reactor core.

### CLAIM OF BENEFIT OF PROVISIONAL APPLICATION

The applicant herein claims the benefit of provisional application No. 60/612,589 filed Sep. 23, 2004.

### FIELD OF THE INVENTION

The present invention relates to boiling water reactors (BWR). More specifically, a new method and device for stabilizing power and flow oscillations of the out-of-phase regional type in the nuclear core of BWR are disclosed.

### BACKGROUND OF THE INVENTION

Boiling Water Reactors are large machines designed for power generation. Power is generated in the reactor core which is placed inside a large pressure vessel. The reactor core is made up of an arrangement of a large number of fuel assemblies also called fuel bundles. Typically, there are 400-800 fuel assemblies in a BWR core. Each of the fuel assemblies is arranged inside a vertical channel of square cross section through which water coolant is injected. Each of the fuel assemblies consist of a plurality of vertical rods arrayed within the said vertical channels in a typically 7×7, 8×8, 9×9, or 10×10 rod matrix. The said rods are sealed cylindrical tubes inside which ceramic pellets of fissionable material, e.g. Uranium oxide, are stacked. The fuel rod tubes, also called cladding, and the outer channel encasing each fuel assembly, are made of a low neutron absorbing metal such as Zirconium alloy. The water flows upward in the channels and removes the heat generated in the pellets by the fission of the heavy isotopes. In addition to its cooling function, the water serves as neutron moderator. The neutron moderation function is achieved as the neutrons produced in the fission process collide with the hydrogen atoms in the water molecules and slow down to lower energies which increase the probability of inducing further fission reactions and the fission chain reaction is sustained.

The water is allowed to boil as it travels up in each fuel assembly channel. The density of water is reduced by the boiling process and the moderating function is adversely affected particularly in the upper portion of the fuel assembly, where the fuel-to-moderator ratio becomes higher than optimally desired. This problem was mitigated in some fuel assembly designs by introducing one or more water rods or channels, henceforth called water channels. A water channel is a hollow tube or conduit extending vertically along the fuel rods, and through which part of the water flows without boiling. Thus, the amount of water available for the neutron moderating function is increased. The said improvement in the moderation function comes at the expense of reducing the amount of water available for the cooling function. Another common improvement in the design fuel assemblies is the use of part-length fuel rods. While the typical active length of a full-length fuel rod is 3.8 m, few short rods in selected array positions are used. The length of a part-length rod is typically half to two-thirds that of the full length rod, and there are typically 8 to 12 part-length rods in each assembly. The space vacated by cutting down the length of some rods is filled with voided coolant (steam-water mixture) flow, and therefore restores the fuel-to-moderator ratio in the top part of the fuel assembly closer to the optimum value for nuclear criticality. The use of part-length fuel rods is also beneficial in reducing the flow resistance in the top part of the assembly as the flow area is increased. However, the use of part-length rods comes at the expense of the amount of fissionable material that can be packed into a fuel assembly.

The reactor core therefore is made of a number of parallel, nuclearly-heated, boiling channels. The core is supported at the bottom with the so-called core support plate, where each of the fuel assembly is seated on a flow opening called inlet orifice. The inlet orifices restrict the flow into each fuel assembly and serve to distribute the total flow into the core evenly among individual fuel assemblies. The core is encased in a cylindrical shroud which separates the upward boiling flow inside the core from the outside down flow in the downcomer, where the latter is the annulus space between the core shroud and the pressure vessel wall. The core shroud is capped at the top by a dome-like structure to form the so-called upper plenum. The liquid water and steam mixture flowing from the exit of the core fuel assemblies mix freely in the upper plenum and continue their upward flow into a set of parallel tubes called standpipes emanating from the upper plenum dome. Each standpipe is fitted with a steam separator device which directs almost dry steam into the upper part of the pressure vessel where it flows into the steam lines leaving the pressure vessels in order to drive steam turbines for the purpose of generating electric power. The saturated water leaving the steam separators is directed to flow down into the water pool that surrounds the standpipes and mix with the lower temperature feedwater returning from the condenser. The water flows downward in the downcomer being driven by a combination of the density head (natural circulation due to density difference between the single phase side outside the core, and the two-phase side in the core and the riser assembly which consists of the upper plenum, the standpipes, and steam separators), and an array of pumps placed in the downcomer. The water leaving the downcomer gather in the so-called lower plenum before it is distributed through the orifices at the bottom of the core, thus completing the recirculation loop.

The nuclear reaction is controlled by the so-called control rods which are neutron absorbing devices that can be moved in the space between fuel assemblies and are driven by mechanisms under the core support place thus occupying part of the space of the pressure vessel lower plenum.

Detailed description of BWR design and operation can be found in Reference (1).

The reactor operation is stable under normal operating conditions, but can depart from stable configuration at conditions of typically high power combined with low flow. The nature of the instability and the unstable modes are outlined below.

The unstable behavior in a BWR is associated with the density waves in vertical boiling channels (fuel assemblies). In the case of a random perturbation to the flow rate at the inlet of the channel, while the energy transfer rate to the coolant remains unchanged, a corresponding enthalpy wave travels upward with the flow. Downstream from the elevation of boiling inception, the flow enthalpy is translated to a steam quality wave where more steam is generated per unit of flow rate to account for an enthalpy increase. The void fraction (by volume) defined as the steam to total volume is generally proportional to the steam quality, and therefore a void fraction wave traveling up the boiling channel results from the originating inlet flow perturbation. The void fraction can be expressed in terms of the average flow density, where maximum density is associated with zero void content, and minimum density is associated with a void fraction of unity. We can therefore speak of a density wave which results from an originating inlet flow perturbation. All flow parameters, mainly flow rate and steam quality and void fraction, are subsequently perturbed and the perturbations travel upward in the boiling channel with a phase lag and are attenuated as the wave travels. High frequency perturbations result in higher attenuation rate, while the zero frequency limit results in no attenuation of the flow rate perturbation.

The density wave alters the flow characteristics in two ways. The first one is that the total weight of the coolant in the channel, which is proportional to the integrated density along the channel, is altered dynamically resulting in a net gravitational pressure drop response. The second way is the change in friction pressure drop along the channel. The friction pressure drop in turn is affected in two ways: the first way is through the change in the flow rate itself (friction being proportional to the square of flow rate), and the second way through the change in the so-called two-phase multiplier which accounts for the increase in frictional pressure drop for higher steam quality. In an idealized situation, the net pressure drop across the channel is kept constant, which leaves a residual component of force to compensate for the driving changes in density head and the changes in friction. The net force accelerates the flow, which reinforces an original flow perturbation of the so-called resonant frequency leading to the potential growth of the oscillation. The density wave degree of stability is reduced for higher power-to-flow ratios and for bottom-peaked axial power distribution as they tend to increase the void content and subsequently the density head feedback which drives the instability. High friction pressure drop at the channel inlet increases kinetic energy dissipation and helps to stabilize density waves, while high friction at higher elevations is destabilizing due to the phase lag of their effect which tends to reinforce the original perturbation.

In a BWR, the oscillation of flow parameters resulting from a density waves is complicated by the double role the water plays in the operation of the reactor. The density wave results in a corresponding neutron moderation effectiveness which in turn results in reactivity and fission power responses. The resulting fluctuation in fission power affects the energy deposition in the coolant directly, and almost instantaneously, through the absorption of gamma rays and the slowing down of neutrons. A larger fraction of fission energy is transferred to the coolant through heat conduction in fuel rods ultimately through the clad surface. The fluctuation of the heat flux through the clad surface is filtered through the heat conduction processes through the fuel rods and the clad surface heat flux experiences a damped and delayed response relative to the fission power itself. The fluctuation of the energy transfer rate to the coolant, both directly and through conduction in the fuel rods, results in corresponding fluctuations in the boiling rate and the coolant density, where such feedback tends to further destabilize the density waves in the boiling channels.

The nuclear-coupled density wave oscillations in a BWR core take one of two main modes. The first mode is the so-called global or in-phase mode. In the global mode, the flow in all the channels in a BWR core oscillate in-phase, resulting in a corresponding oscillation in the reactor power. The coherence of the individual channel oscillations is maintained by their collective excitation of the fundamental neutron flux mode. In that manner, the power distribution between different fuel channels remains virtually unchanged while the net power itself oscillates in the so-called global mode. It is important to notice that coherent power and flow oscillations in all the fuel channels results in net core flow oscillations which must traverse the entire recirculation loop starting from the riser components and down through the downcomer back to the core inlet. The recirculation loop friction and inertia tend to stabilize the global mode.

The second mode of nuclear-coupled density wave oscillations in a BWR is the so-called regional or out-of-phase mode. In the regional mode, the flow oscillations in one half of the core channels oscillate in phase with each other, but out-of-phase with the bundles in the other core half. The two half cores are separated by a neutral line which passes through the core center. The said neutral line is the horizontal projection of a vertical plane which passes through the centerline of the nearly-cylindrical core and divides the core in two halves or equivalently two groups of bundles lying on either side of the neutral plane. Flow and power oscillations are virtually zero for bundles lying along the neutral line. The reactivity oscillations resulting from the flow oscillations do not change the net reactivity in the core and therefore does not excite the fundamental flux mode. Instead, they excite a higher harmonic of the neutron flux which is subcritical. The higher neutron flux harmonic is the so-called first azimuthal mode which is positive in one core half where the channels oscillate together in-phase, and negative in the other half core. The harmonic flux is zero along the neutral line separating the core radially in two halves. The reactivity of the first azimuthal harmonic is the same as that of a half core and therefore subcritical. It is important to know that on the basis of neutronic response, the excitation of the first harmonic is less favored than the fundamental mode because of the first harmonic damping due to its subcriticality. On the basis of the hydraulic response, the regional mode is favored to the global mode because the damping effect the global mode flow experiences as it must interact with the recirculation loop. The regional mode flow oscillation in one half of the core cancels out the out-of-phase flow oscillation in the other half, and the net flow remains virtually unchanged. One can think of this situation as an oscillating flow component which is a loop that traverses the following path: down through one half of the core assemblies, then crossing the lower plenum and continue upwards through the other half of the core assemblies, and completes the loop laterally through the upper plenum. This regional flow oscillation loop does not need to go through the recirculation loop and thus avoids its damping effect.

The regional mode instability tends to be more favored for large BWR cores as the degree of subcriticality is smaller in large cores. It is also favored in plants designed with large inlet orifices, which favors the hydraulic component of the regional oscillation loop.

The operation of BWR under oscillating conditions is not permitted by the Nuclear Regulatory Commission (NRC) in the US or its equivalent authorities in foreign countries. This restriction is placed in order to avoid violating the thermal limits in the fuel, potentially resulting in fuel damage under such oscillatory power and flow conditions. While operating under global or regional oscillations is equally undesirable, the regional mode of oscillation is considered the more challenging of the two. This is mainly because the net power signal from the Average Power Range Monitor (APRM) does not account for the regional mode oscillations as the average signal combines signals from Local Power Range Monitors (LPRM) from both sides of the oscillating core, and thus tend to cancel out making the detection of the regional mode difficult. It is not possible to get signals from only one side because the neutral line defining the core sides is not known a priori and its preferred orientation, if one exists, is not easily predictable and may change throughout the operating cycle of the reactor. The situation can be complicated further by the possibility that the neutral line separating the core in two may undergo rotation at the main oscillation frequency or its orientation change in a stochastic unpredictable manner making the identification of a fixed oscillation spatial pattern unfeasible. The regional mode oscillation detection is therefore more difficult compared with that of the global mode.

The consequences of a regional mode power oscillation are also more challenging compared with the global mode. It is known that for the same relative power signal amplitude indicating unstable behavior of either mode, the resulting degradation of the thermal operating limit due to regional mode oscillations is about twice as much as the corresponding degradation of the thermal limits if the oscillations were of the global mode type. Thus, the regional mode is more challenging than the global mode in both the detection and the consequence fronts.

A detailed report on density wave instabilities and oscillations in BWR's can be found in Reference (2).

The prior art dealt with stability issues in various ways. In one way, new fuel designs aim at maintaining the level of stability as the preceding designs, but actual improvements could hardly be achieved without negatively impacting other parameters important to the economic performance of fuel designs such as power density. Modern fuel designs tend to include larger number of small diameter rods, which are less stable due to decreasing the rod heat conduction time constant. The use of part-length rods tends to stabilize the hydraulic flow through reducing flow resistance in the top part of the channel, but comes at the expense of reducing the mass of the fissionable material load in each fuel bundle. The use of water channels improves stability through reducing the relative dependence on the steam-water mixture coolant for neutron moderation, but it comes at the expense of reduced number of fuel rods. In general, fuel design modifications are not sufficient to achieve unconditional stability. Another way of dealing with BWR stability is limiting the degree of axial and radial power peaking variations anticipated in the design of a reload fuel cycle, which adversely affects the net energy that can be generated by the cycle. The most effective way to deal with the potential for instability in the prior art is the operations option. In one of these operational solutions, the operation of the reactor is restricted inside a pre-calculated so-called exclusion zone, which is an area in the power-flow map characterized by high power-to-flow ratio. This restriction poses undesirable limitations to operational flexibility. The other operational solution is the so-called detect and suppress (D&S) solution, where an automatic shut down is initiated upon detection of oscillatory behavior. The D&S solution has the undesirable potential of causing unnecessary shut down due to the necessity of setting the detection system at hypersensitive level in order to detect any regional oscillations.

The prior art is silent concerning selective damping of the regional mode, to which this invention is devoted.

### BRIEF SUMMARY OF THE INVENTION

In accordance with the present invention, a new method for stabilizing the regional mode out-of-phase power and flow oscillations in BWR is introduced. The new method is realized using a flow partition device in the upper and/or lower core plenum. The said partition device divides plenum flow area in three or more flow paths. The partition devices work by introducing flow resistance to the flow loop through fuel assemblies in any two core halves regardless of the orientation of the vertical plane separating the said two core halves. The new partition devices introduce minimal resistance to the normal flow path thus avoiding any negative impact on normal operation.

### BRIEF DESCRIPTION OF THE DRAWINGS

FIG. 1 is an elevation section of a BWR vessel (100) showing the core (200), core shroud (300), shroud head (400), upper plenum volume (500), steam separator assembly (600), steam dome (800), and water level (900). Arrows indicating flow direction (700) refer to normal stable operation.

FIG. 2-a is an elevation section depicting part of the BWR vessel shown in FIG. 1. FIG. 2-a depicts the core (200), core shroud (300), shroud head (400), upper plenum volume (500), arrows flow components during normal operation (700), and arrows indicating oscillating flow component during a regional mode oscillation (710).

FIG. 2-b is a plan section from FIG. 1-a from the top of the core (200) showing fuel assemblies divided in two core halves marking an east-west regional oscillation. The east and west core halves are marked (+) and (−) respectively.

FIG. 3-a is an elevation section similar to FIG. 2-a, with the exception that a vertical partition (1000) device is placed in the upper plenum (500) in contact with the shroud head (400) and extending downwardly proximal the core (200).

FIG. 3-b is a plan section from the top of the core (200) similar to FIG. 2-b, with the exception that the vertical partition (1000) device is shown dividing the upper plenum (500) in two halves (east and west). The orientation of the flow oscillation is rotated by 90 degrees relative to that shown in FIG. 2-b. The assemblies in the north core half are marked (+) to indicate their flow oscillation out-of-phase with the flow in the assemblies in the south core half marked (−).

FIG. 3-c is an isometric to further illustrate the placement of the partition (1000) affixed to the bottom side of the shroud head (400), where the shroud head is removed for the purpose of illustration from the top of the shroud (300).

FIG. 4-a is an elevation section similar to FIG. 2-a, with the exception that a tri-partition (2000) device is placed in the upper plenum (500) in contact with the shroud head (400) and extending downwardly proximal the core (200).

FIG. 4-b is a plan section from the top of the core (200) similar to FIG. 2-b, with the exception that a tri-partition (2000) device is shown dividing the upper plenum (500) in three parts.

FIG. 4-c is an isometric to further illustrate the placement of the tri-partition (2000) affixed to the bottom side of the shroud head (400), where the shroud head is removed for the purpose of illustration from the top of the shroud (300).

FIG. 5-a is an elevation section similar to FIG. 2-a, with the exception that a quad-partition (3000) device is placed in the upper plenum (500) in contact with the shroud head (400) and extending downwardly proximal the core (200).

FIG. 5-b is a plan section from the top of the core (200) similar to FIG. 2-b, with the exception that a quad-partition (3000) device is shown dividing the upper plenum (500) in four parts.

FIG. 5-c is an isometric to further illustrate the placement of the quad-partition (3000) affixed to the bottom side of the shroud head (400), where the shroud head is removed for the purpose of illustration from the top of the shroud (300).

### DETAILED DESCRIPTION OF THE INVENTION

The basic principle of how the new flow partition device works is explained by considering a series of situations where a regional oscillation takes place in a BWR core without intervention, then with a device dividing the flow in the upper plenum in two, and lastly with a device dividing the upper plenum in three or more flow paths.

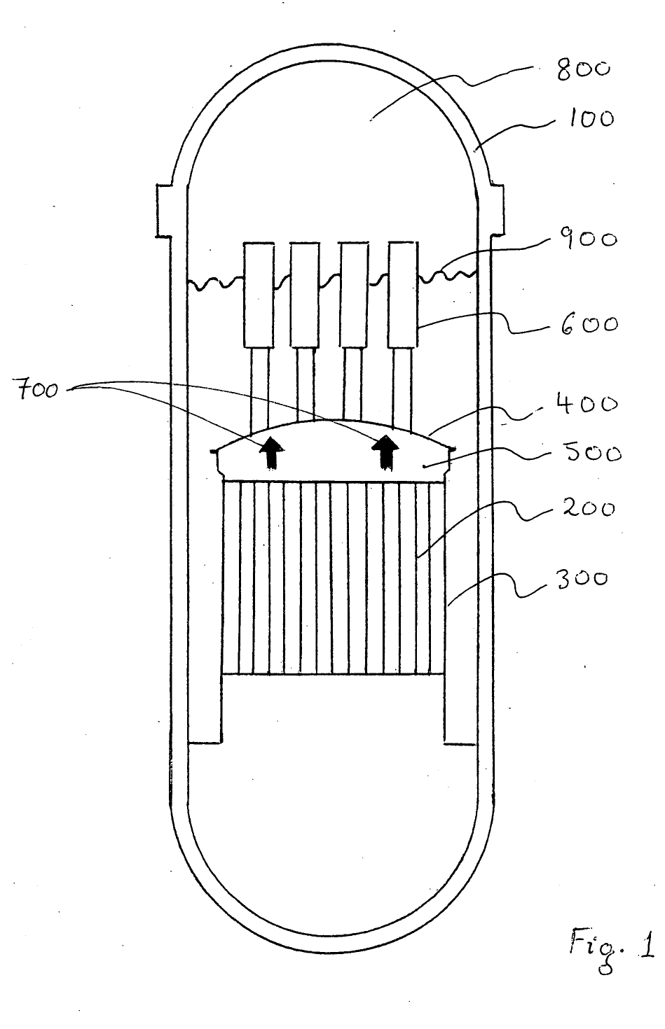

FIG. 1 depicts a sketch of an elevation section of a BWR vessel (100) inside which the nuclear core (200) is surrounded by the core shroud (300). The shroud head (400) is the dome-like structure resting on top of the core shroud creating the upper plenum (500) inside which the steam-water mixture exiting the core fuel assemblies is mixed and flows upward into the steam separator assembly (600). The normal flow direction of the steam-water mixture discharged from the core into the upper plenum is shown in FIG. 1 by the vertical upward arrows (700) which denote the flow of the steam-water mixture exiting the fuel assemblies and gathering in the common upper plenum. The steam separator assembly (600) receives the steam-water mixture flow and discharges steam into the steam dome (800) while the separated water is charged into the vessel where the water level is marked (900).

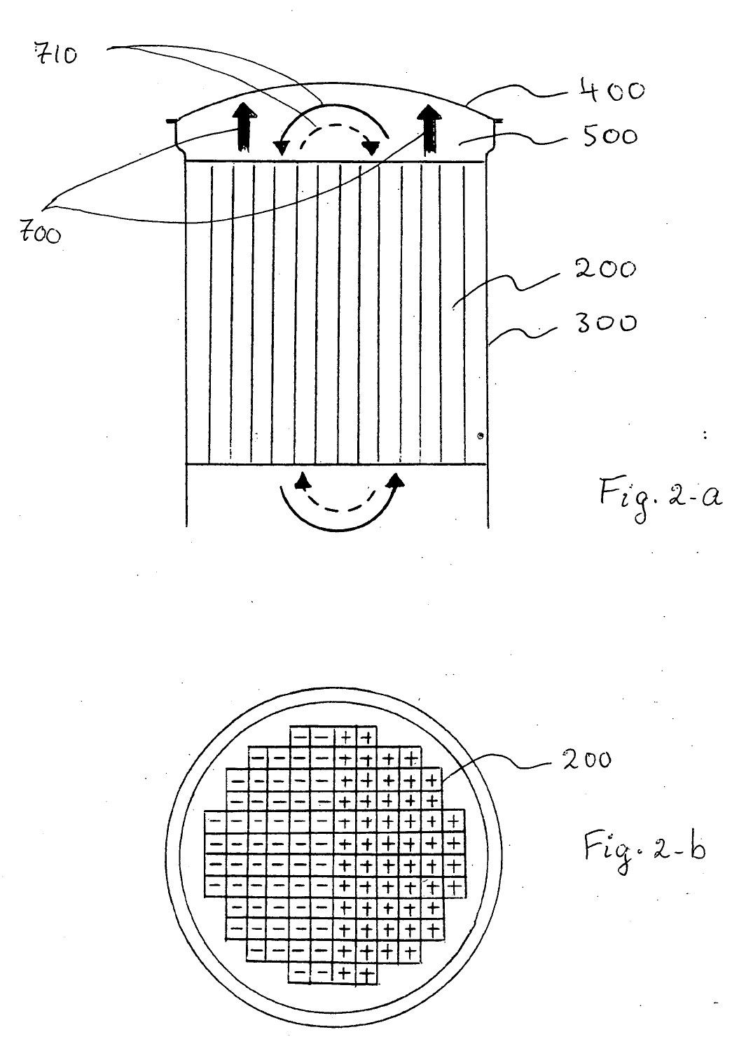

FIG. 2-a is a sketch of an elevation section depicting the core (200), core shroud (300), shroud head (400), and upper plenum volume (500), which is part of the BWR sketch shown in FIG. 1. Two flow components are shown in FIG. 2-a. The first flow component is the normal vertical component marked by the arrows (700) which denote the flow of the steam-water mixture exiting the fuel assemblies and gathering in the common upper plenum. The second flow component is marked by the opposite arrows (710), which denote an oscillating flow loop which goes clockwise for one half of its oscillation cycle taking flow from the assemblies in one core half and returning the flow into the assemblies in the other core half. The flow direction reverses in the subsequent half oscillation cycle. The oscillating flow loop component travels through the common upper plenum unimpeded and the resulting change in the flowing fluid density creates a corresponding reactivity and power oscillation which alternates power peaks in the two core sides known as the regional out-of-phase oscillation.

FIG. 2-b depicts a sketch of a plan section of the top of the core showing fuel assemblies divided in two sides (east and west). The assemblies in the west side are marked (+) to indicate an increased exit flow in said assemblies during half oscillation cycle, which correspond to the half cycle during which the flow loop component depicted in FIG. 2-a is going clockwise. The assemblies in the other core half are marked (−) to indicate reduced core flow. The net flow through the steam separator assembly remains unaffected by the oscillating flow loop component.

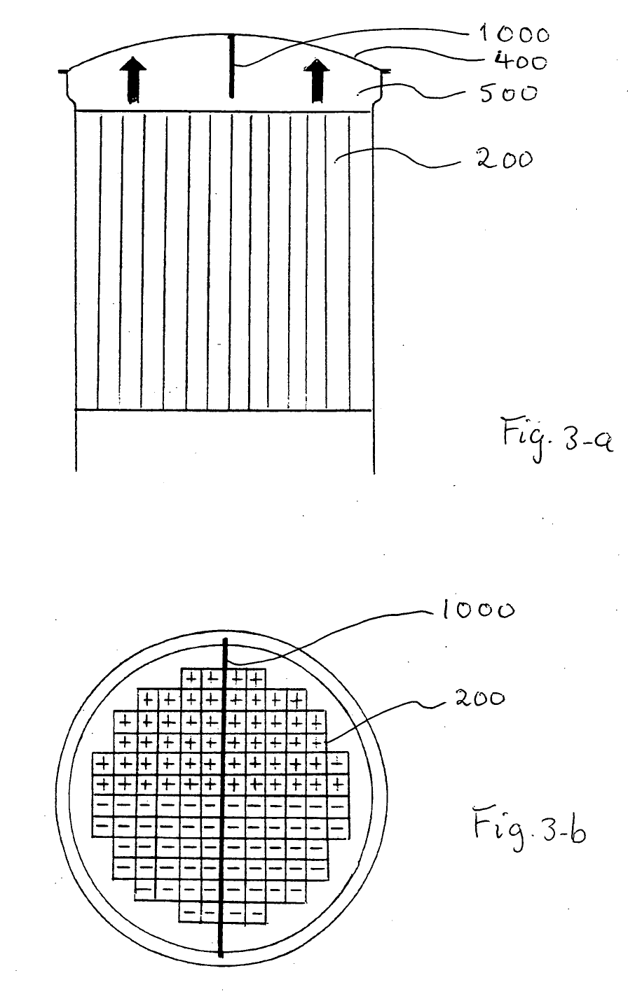

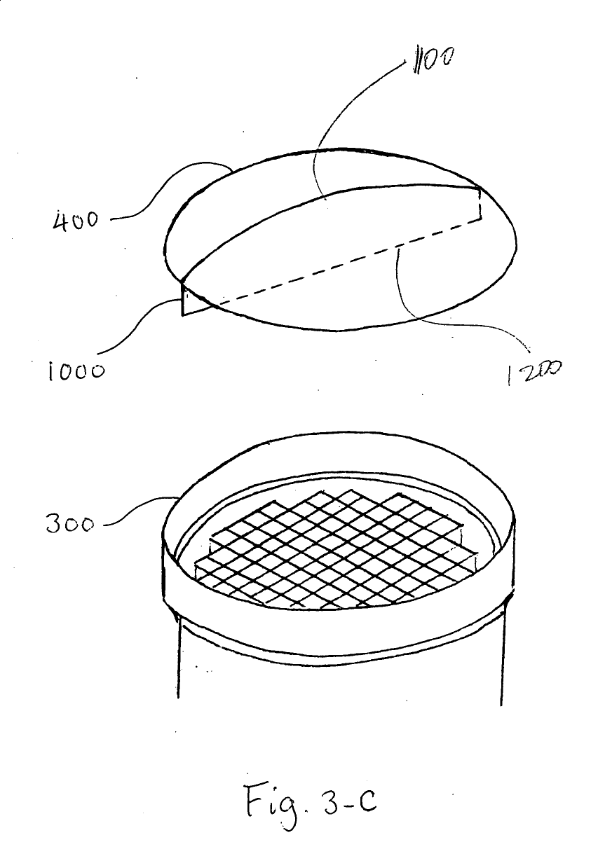

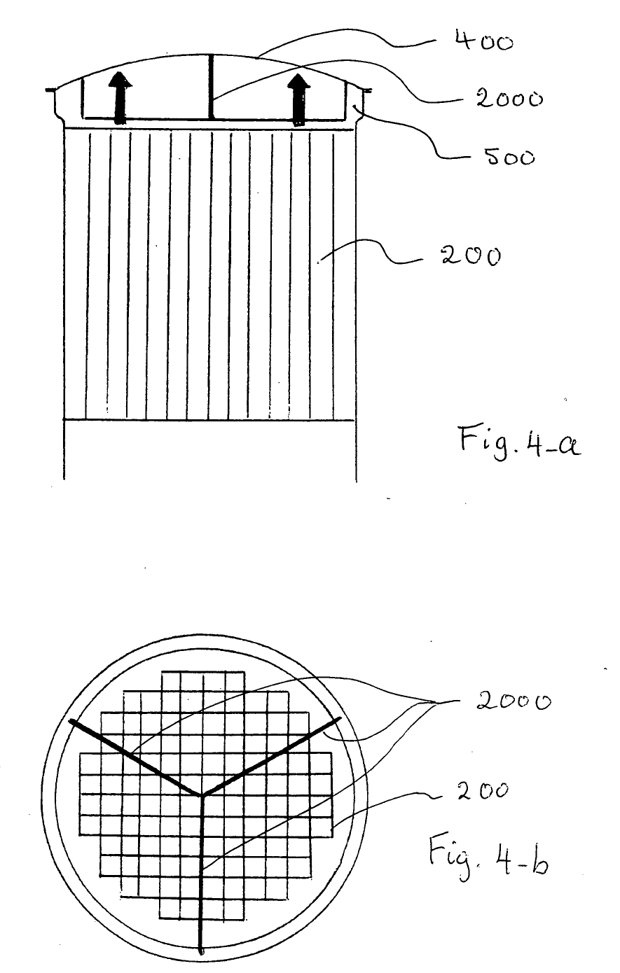

FIGS. 3-a and 3-b are similar to FIGS. 2-a and 2-b with the exception that a vertical partition (1000) is placed in the upper plenum along the north-south axis. The vertical partition (1000) is substantially planar having a partition top (1100) fixed to the bottom side of the shroud head (400). The partition (1000) extends diagonally proximal to the wall of the core shroud (300), and extends downwardly proximal to the top of the core (200) at the core top. The plan section of FIG. 3-b shows the partition (1000) to extend on top of the core along the north-south axis thus separating the upper plenum into an east and a west side. FIG. 3-c is an isometric to further illustrate the placement of the partition (1000) affixed to the bottom side of the shroud head (400), where the shroud head is removed for the purpose of illustration from the top of the shroud (300).

The method of partitioning the upper plenum in two substantially prevents the east-west oscillating flow loop from going through the upper plenum forcing it to flow through the steam separator assemblies, which would bring it to a more stable configuration relative to the global mode (because global mode oscillating flow has to go through the steam separator assembly but is preferred because it excites the undamped fundamental neutron flux mode). However, the partition configuration dividing the upper plenum in two flow paths is not useful, as the orientation of the neutral line would simply rotate by 90 degrees and the core power and flow will oscillate on a north-south pattern. The north-south division of the core is shown in FIG. 3-b by marking the fuel assemblies in the north half by (+) and the south half by (−).

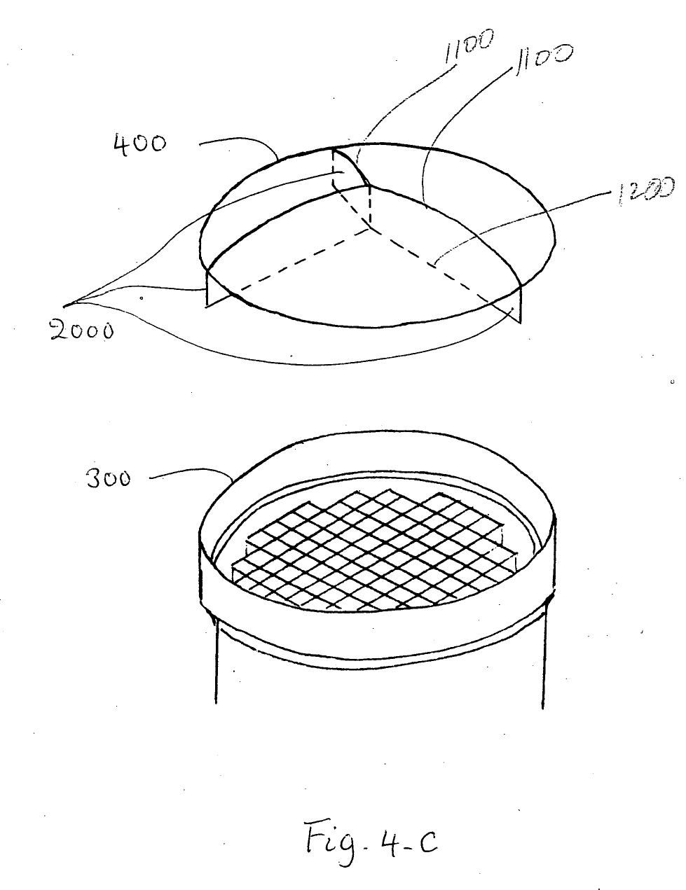

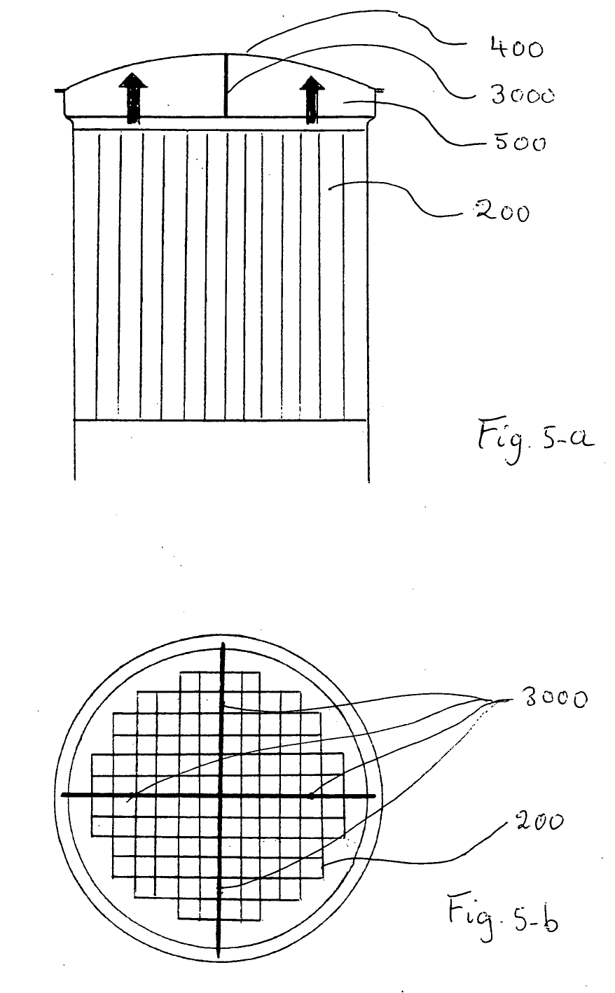

FIGS. 4-a and 4-b are similar to FIGS. 3-a and 3-b with the exception that a tri-partition (2000) is placed in the upper plenum volume partitioning it in three. The partition (2000) is made up of three substantially planar sides (2100, 2200, and 2300). The partition sides (2100, 2200, and 2300) extend radially proximal to the wall of the core shroud (300), and extend downwardly proximal to the top of the core (200) at the core top. FIG. 4-c is an isometric to further illustrate the placement of the tri-partition (2000) affixed to the bottom side of the shroud head (400), where the shroud head is removed for the purpose of illustration from the top of the shroud (300).

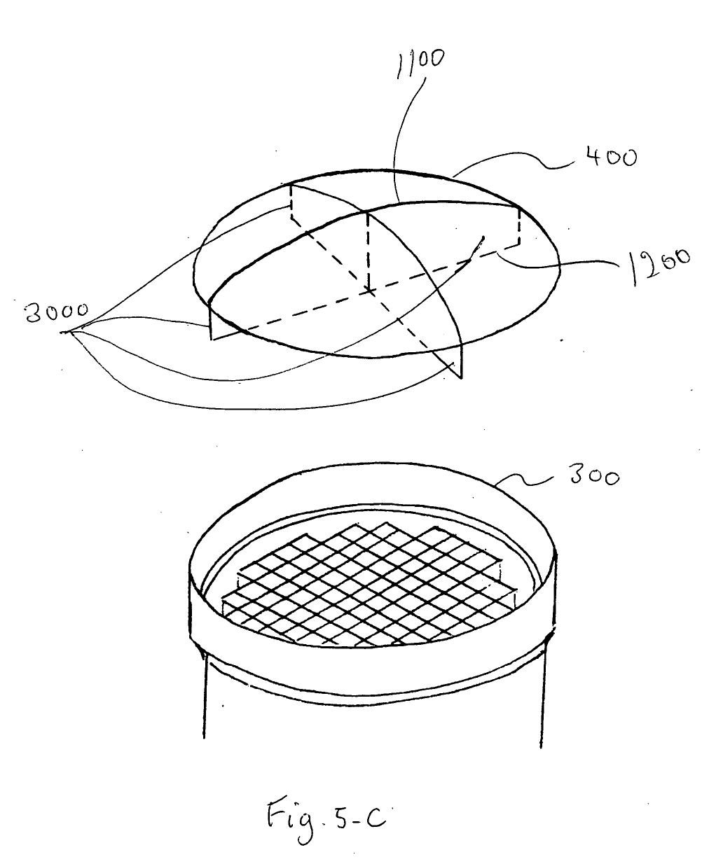

FIGS. 5-a, 5-b, 5-c are similar to FIGS. 4-a, 4-b, 4-c with the exception that the tri-partition is replaced with a quad-partition (3000) which divides the flow path in the upper plenum in four. The orientation of the tri-partition (2000) and the quad-partition (3000), as seen in FIGS. 4-b and 5-b is arbitrary, effectively preventing all side by side oscillating flow loops from going laterally through the upper plenum (300).

Those of ordinary skill in the nuclear reactor arts will recognize that the partition invention disclosed herein may be comprised of 1 . . . n segments or partition divisions; the size of each of the said divisions need not be exactly equal to other divisions. They also recognize that practical modifications to the idealized partition shapes depicted in the above Figs. can be made in order to avoid blocking the flow entrance to any standpipe or adapt to the geometry of other structures that may exist in the upper plenum volume. They also recognize that a clearance between the bottom of the partition structure and the top of the core as well as a clearance between the partition structure and the inner core shroud walls may be necessary, but said clearances must be limited in extent such that the basic function of the partition to provide substantial upper plenum flow resistance in the lateral direction to dampen all side-by-side flow oscillation modes is maintained while any allowed flow patterns would result in exciting neutron flux harmonics that are highly subcritical and thus highly damped.

The three path partition device (henceforth named Mercedes Partition) in the upper plenum is one preferred embodiment of this invention. The four path partition device (henceforth named Cruciform Partition) in the upper plenum is another preferred embodiment of this invention. Similar partitions in the lower plenum are also effective in damping the regional mode oscillation following the same principle as the partitioning of the upper plenum. However, considerations of geometrical interference with the control rod drives in the bottom of the core and the need to maintain uniform flow even when the pumps are not operating symmetrically make the upper plenum partitioning preferable to lower plenum partitioning as a method for damping regional mode oscillations in current BWR designs but can be reconsidered for future BWR designs.

I claim:

1. A method for stabilizing the regional mode power/flow oscillations in a boiling water reactor core by introducing flow resistance or partitions in the common flow plena above or below the said core, where the said resistance or partitions function to reduce or prevent the flow communication between any two groups of fuel assemblies where the vertical plane dividing the fuel assemblies in the said two fuel assembly groups is oriented arbitrarily.

2. A partition device that divides the flow path in the upper plenum of a boiling water reactor into three or more azimuthal sections for the purpose of introducing flow resistance to stabilize the regional mode power and flow oscillations.

3. A partition device that divides the flow path in the lower plenum of a boiling water reactor into three or more azimuthal sections for the purpose of introducing flow resistance to stabilize the regional mode power and flow oscillations.

4. A partition device for stabilizing the regional mode power/flow oscillations in a boiling water reactor core of claim 2 comprised of three azimuthal sections; the said partition sections are affixed to the bottom side of the core shroud head.

5. A partition device for stabilizing the regional mode power/flow oscillations in a boiling water reactor core of claim 2 comprised of four azimuthal sections; the said partition sections are affixed to the bottom side of the core shroud head.

6. A method for stabilizing the regional mode power/flow oscillations in a boiling water reactor core comprising:
a. introducing flow resistance means in a common flow plena, above or below a core contained within a core shroud (300), where the said resistance means reduces or prevents flow communication, between any two groups of fuel assemblies contained within said core, where a vertical plane dividing the fuel assemblies in the said two fuel assembly groups is oriented arbitrarily.

7. A method for stabilizing the regional mode power/flow oscillations in a boiling water reactor core of claim 6 further comprising:
a. introducing flow resistance means by affixing, by nuclear shroud affixing means, partition means at an interior surface of said common flow plena;
b. orienting said partition means to establish three or more azimuthal sections for the purpose of introducing flow resistance to stabilize the regional mode power and flow oscillations.

8. A method for stabilizing the regional mode power/flow oscillations in a boiling water reactor core of claim 7 further comprising:
a. forming said partition means by at least one partition (1000) which is substantially planar having a partition top (1100), fixed to the interior surface of the core shroud, and a partition bottom (1___).

9. A method for stabilizing the regional mode power/flow oscillations in a boiling water reactor core of claim 8 further comprising:
a. affixing, by nuclear shroud affixing means including welding, the at least one partition in a generally vertical orientation relative to the core;
b. extending the partition (1000) diagonally proximal to a wall of the core shroud (300), and extending downwardly proximal to a top of the core (200) or upwardly proximal to a bottom of the core (200).

10. A method for stabilizing the regional mode power/flow oscillations in a boiling water reactor core of claim 9 further comprising:
a. the at least one partition comprised of a plurality of partitions.
